(19) United States
(12) Patent Application Publication
(10) Pub. No.: US 2025/0339954 A1
(43) Pub. Date: Nov. 6, 2025

(54) ROBOTIC COMPLIANT ACTUATOR WITH SERIES ELASTIC COMPLIANT MECHANISM

(71) Applicant: Devol Robots Sdn. Bhd., Petaling Jaya (MY)

(72) Inventors: Yi Herng Ong, Ulu Tiram (MY); Sze Yuan Cheong, Johor Bahru (MY)

(73) Assignee: Devol Robots Sdn. Bhd., Petaling Jaya (MY)

(21) Appl. No.: 19/200,572

(22) Filed: May 6, 2025

Related U.S. Application Data
(60) Provisional application No. 63/642,931, filed on May 6, 2024.
(60) Provisional application No. 63/706,001, filed on Oct. 10, 2024.

(51) Int. Cl. B25J 9/00; B25J 9/10; B25J 9/12; B25J 19/02

(52) U.S. Cl. CPC B25J 9/0009; B25J 9/102; B25J 9/109; B25J 9/126; B25J 19/02

(57) ABSTRACT

The innovation of the robotic compliant actuator derives from the utilization of the series elastic actuation principle, coupled with the fundamentals in compliant mechanics. This actuator constitutes a dynamic and adaptable actuation framework wherein an elastic component is sequentially integrated with a motor and gearbox, resulting in compelling force-regulating attributes. This actuation concept has been specifically customized for robotic systems, particularly robot manipulators and legged robots, fundamentally transforming the manner in which robots engage with their surroundings, executing tasks demanding precision, adaptability, and safety. This compliant actuator introduces an ingeniously designed mechanical spring that assimilates a compliant mechanism within its elastic component, thereby endowing itself with additional benefits inherent to compliant mechanics. Additionally, another layer of compliant mechanism serves as an amplification means to detect spring displacement. This augmentation aptly exemplifies human-like force-regulation behavior, particularly in the realm of robotic applications.

### CROSS-REFERENCE TO RELATED APPLICATIONS

This application claims the benefit of U.S. Provisional Patent Application No. 63/706,001, filed on Oct. 10, 2024, drawn to a Robotic Compliant Actuator with Series Elastic Compliant Mechanism, and U.S. Provisional Patent Application No. 63/642,931, filed on May 6, 2024, drawn to a Robotic Compliant Actuator with Series Elastic Compliant Mechanism, which are incorporated by reference herein in their entirety.

### FIELD OF THE PRESENT DISCLOSURE

The invention relates generally to compliant actuators. More specifically, the present disclosure is related to a rotary compliant actuator with improved force exertion sensing capabilities.

### INTRODUCTION

Robots are mechanical or virtual devices designed to carry out tasks autonomously or semi-autonomously, often with the ability to mimic human or animal movements and behaviors. The field of robotics encompasses their design, construction, operation, and application across various industries. In a wide variety of applications, robots are often physically constructed with actuation systems, physical linkages, gear transmission systems, and the like. Although every component is essential to the overall system, an actuation system or actuator plays the most critical role in motion generation for the robot such that it can move smoothly in its environment, ultimately completing its assigned tasks.

An actuator is a crucial component that generates controlled movement or force in response to a signal. It's essential in systems like robotics and machinery, converting energy into mechanical action for specific tasks. Actuators play a vital role in tasks such as adjusting valves, moving robot joints, and more. They can be powered by electric motors, hydraulics, or pneumatics, and come in various types, like linear for straight motion and rotary for rotation.

The majority of robotic systems, such as robotic manipulators, are using position control-oriented actuators to generate motions and trajectories. One of the reasons for this is that the environments where they are deployed are more controlled (for example, factories, manufacturing facilities, production lines, and the like) and these robots are programmed to do repetitive and precise tasks. The tasks that were assigned to robots usually require high precision. Hence, a position-control robot with stiff linkages and actuation is suited to excel these settings.

Yet for those tasks that are required to be completed in dynamic settings, position-control robots may not excel because they do not possess essential information such as force feedback to appropriately react in the environment. A force torque sensor that is equipped with electromechanical systems such as strain-gauges is then designed and attached to the robotic joint to interact with the environment. Although it can collect an abundant amount of force data, the force data resolution and bandwidth are still not satisfactory for precise force-control for robots.

### SUMMARY

Aspects of the present disclosure may relate to a compliant actuation system. In an embodiment, the system may comprise a compliant actuator, wherein the compliant actuator may include an actuator coupled to an elastic element. For instance, the elastic element may be configured to undergo an amount of deflection in a first direction, and the amount of deflection may be proportional to an external force exerted by the actuator. The compliant actuator may further comprise a deflection sensing mechanism configured to measure a deflection of the elastic element.

In an embodiment, the deflection sensing mechanism may include an amplification mechanism, the amplification mechanism comprising at least one of a gear-cam coupled to the elastic element. Such a gear-cam may be configured to rotate in an opposite direction to the first direction; and a linkage system may be coupled to the gear-cam, wherein the linkage system is configured to distort in proportion to the rotation of the gear-cam.

Furthermore, the linkage system may comprise a four-bar linkage mechanism. Moreover, the gear-cam may magnify the deflection by a first amplification factor of m, and the linkage system may magnify the deflection by a second amplification factor of n. For example, a total amplification factor is the product of the first amplification factor of m and the second amplification factor of n.

In a further embodiment, the elastic element may be further comprised of one or more spokes, wherein the one or more spokes are configured to experience deflection proportional to the external force exerted by the actuator.

Additionally, the measured deflection of the elastic element may correspond to the external force exerted by the actuator.

In another embodiment, the actuator may be configured to adjust the external force exerted by the actuator based on the measured deflection of the elastic element.

Further, the amount of deflection may be linearly proportional to the external force exerted by the actuator.

Aspects of the present disclosure may also relate to a system, including an elastic element that may be configured to undergo deflection in response to an external force; and a deflection sensing mechanism coupled to the elastic element. For instance, the deflection sensing mechanism may include a gear-cam and a linkage system; the gear-cam may be configured to rotate in a direction opposite to the deflection of the clastic element and magnify the deflection by a first amplification factor; the linkage system configured to distort in proportion to the rotation of the gear-cam and magnify the deflection by a second amplification factor.

In an embodiment, the elastic element may include one or more spokes configured to experience deflection proportional to the external force.

In another embodiment, the gear-cam may be configured to magnify the deflection by a first amplification factor greater than one.

Moreover, the measured deflection of the elastic element may correspond to the external force exerted by the actuator.

In yet another embodiment, the linkage system may include a four-bar linkage mechanism.

Additionally, the gear-cam may be configured to rotate in a direction opposite to the deflection of the elastic element and magnify the deflection by the first amplification factor.

Furthermore, the linkage system may be configured to distort in proportion to the rotation of the gear-cam and magnify the deflection by the second amplification factor.

Aspects of the present disclosure may also relate to a compliant actuation system. To illustrate, such a system may be comprised of an elastic element configured to undergo deflection in response to an external force. The elastic clement may be comprised of an outer ring having a plurality of mounting holes distributed around its circumference, an inner hub, a plurality of flexure spokes extending radially between the outer ring and the inner hub, mechanical hardstops positioned to limit radial travel of the flexure spokes; and a deflection sensing mechanism coupled to the clastic element. Further, the deflection sensing mechanism may comprise a cam affixed to the inner hub of the clastic element, a driving linkage pivotally mounted and configured to engage with the cam, a driven linkage pivotally mounted and configured to be actuated by the driving linkage, and a sensing rotor coupled to an output of the driven linkage.

In an embodiment, each of the plurality of flexure spokes may incorporate one or more flexible hinges allowing controlled deformation.

In another embodiment, the cam may be configured to translate rotational deflection of the clastic element into radial displacement.

In yet a further embodiment, the driving linkage may be configured to convert the radial displacement into rotational motion.

This Summary is provided to introduce a selection of concepts in a simplified form that are further described below in the Detailed Description. This Summary is not intended to identify key features or essential features, nor is it intended to limit the scope of the claims included herewith.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates an example of a robotic compliant actuator in panel view;

FIG. 2A illustrates an example of a robotic compliant actuator with transparent housing in a side view;

FIG. 2B illustrates an example of a robotic compliant actuator with an opening to show a side view of the elastic clement;

FIG. 3 illustrates an example of a bottom view of a robotic compliant actuator;

FIG. 4 illustrates an example of a front view of a robotic compliant actuator;

FIG. 5 illustrates an example of a section view of a robotic compliant actuator;

FIG. 6 illustrates an example of a side view of a robotic compliant actuator;

FIG. 7 illustrates an example of a side view of a robotic compliant actuator without housing;

FIG. 8A illustrates an example of a first embodiment of an elastic element that combines both mechanical spring and mechanical device for force sensing;

FIG. 8B illustrates an example of a second embodiment of an elastic element that combines both mechanical spring and mechanical device for force sensing;

FIG. 9A illustrates an example of a front view of a first embodiment of an elastic element combined with deflection amplification element;

FIG. 9B illustrates an example of a front view of a second embodiment of an elastic element combined with deflection amplification element;

FIG. 10 illustrates an example of an inside view of an elastic element;

FIG. 11A illustrates an example of a first embodiment of a mechanical spring that incorporates compliant mechanism design;

FIG. 11B illustrates an example of a second embodiment of a mechanical spring that incorporates compliant mechanism design;

FIG. 12 illustrates an example of a rhombus-bridge type compliant mechanism implemented for deflection detection;

FIG. 13 illustrates an example of a full mechanical device that incorporates bridge mechanism to amplify spring deflection for force sensing;

FIG. 14 illustrates an example of a robotic compliant actuator in panel view;

FIG. 15 illustrates an example of a motor gearbox actuator in panel view;

FIG. 16 illustrates an example of a side view of a spring assembly;

FIG. 17 illustrates an example of a rear view of a spring assembly;

FIG. 18 illustrates an example of a 4-bar linkage mechanism for deflection detection;

FIG. 19 illustrates an embodiment of a mechanical spring component incorporating a compliant mechanism design;

FIG. 20 illustrates an embodiment of an orthogonal front view of a cam-lever mechanism;

FIG. 21 illustrates an embodiment of a panel view of a cam-lever mechanism;

FIG. 22 illustrates an embodiment of a section view of an elastic actuator assembly showing the internal arrangement of components;

FIG. 23 illustrates an embodiment of a section view of a rotary compliant actuator showing the internal arrangement of components;

FIG. 24 illustrates an embodiment of an orthogonal front view of a mechanical spring component incorporating a compliant mechanism design;

FIG. 25 illustrates an embodiment of cam-lever mechanism;

FIG. 26 illustrates an embodiment of a complete elastic element in panel view; and

FIG. 27 illustrates an embodiment of a complete robotic compliant actuator in panel view.

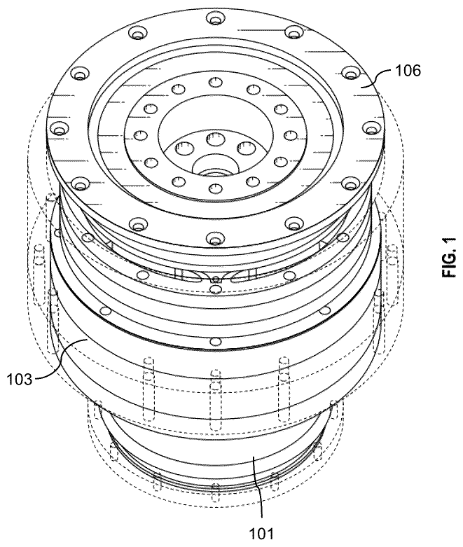

Corresponding reference characters indicate corresponding parts throughout the several views. The exemplifications set out herein illustrate embodiments of the of the present disclosure and such exemplifications are not to be construed as limiting the scope of the invention in any manner.

### DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

A Series Elastic Actuator (SEA) (also referred to as a “robotic compliant actuator”) is a dynamic and compliant actuation system that integrates an elastic element in series with a traditional actuator which includes an electric motor, gear transmission and encoders. This configuration achieves desirable force-controlling characteristics, while offering a range of advantages that include inherent compliance, shock absorption, and improved energy efficiency. The clastic element in an SEA absorbs and stores energy, enabling the actuator to handle impacts and external forces more effectively. This compliance mimics the behavior of muscles and tendons in biological systems, making SEAs well-suited for tasks requiring delicate force interactions or adaptability in uncertain environments.

Many conventional SEAs have been developed with various types of springs, including custom spring designs. Yet none of such conventional SEAs exploit the advantages of compliant mechanisms. Compliant mechanisms represent a paradigm shift in mechanical engineering, offering innovative solutions for a multitude of engineering challenges. Unlike traditional rigid-body mechanisms, compliant mechanisms derive their functionality from the flexibility and deformation of their constituent materials, eliminating the need for traditional joints and linkages. The improved SEA described herein employs the concept of compliant mechanics by implementing the mechanisms into the design of the elastic element. The mechanical spring employs a compliant mechanism and is designed to exhibit a linearly elastic relationship in its characteristics. In addition, a device is designed to detect spring deflection, and a compliant mechanism is integrated into the design to efficiently amplify the deflection for better sensing ability and higher resolution.

Further, a system and method are derived to determine the dimension of the mechanical spring through manipulation of design parameters. The main purpose of such a system and method is to scale the mechanical spring for a range of torque capacities. The parameters encompass material properties such as yield strength, mechanical hysteresis, and safety factor, while the parameters also need to include geometric parameters that contain the ratio of inner and outer ring diameters, spoke radius, and distance profiles of the flexure hinges. A nonlinear mathematical relationship has been established with these parameters, as well as experimental coefficients, streamlining the process of determining a new mechanical spring variant with different torque capacities.

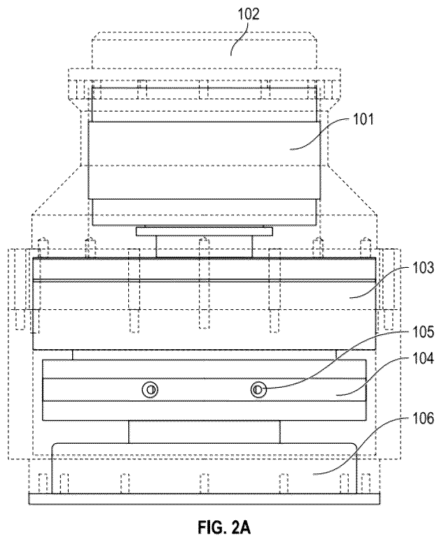

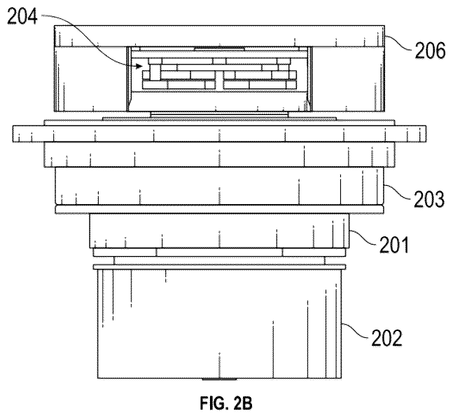

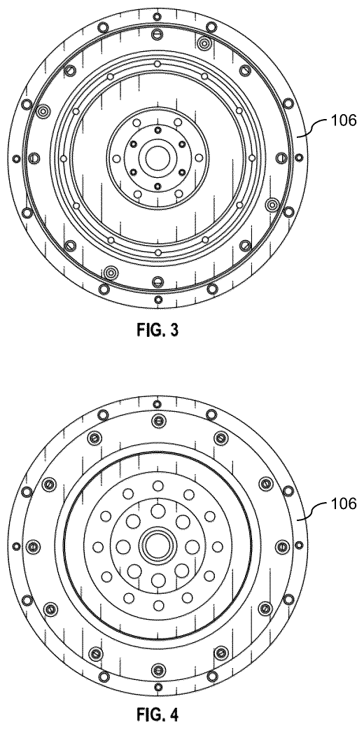

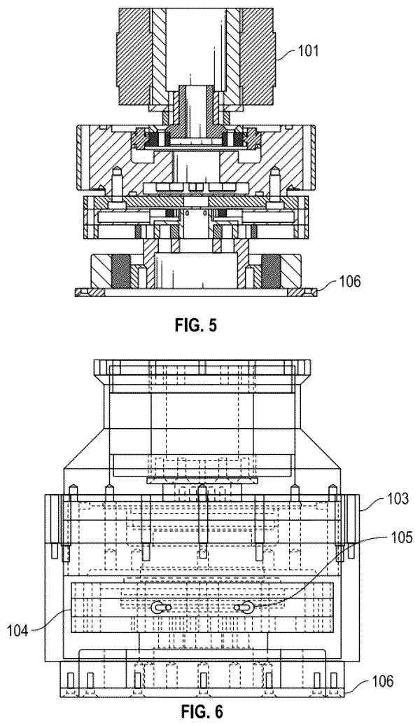

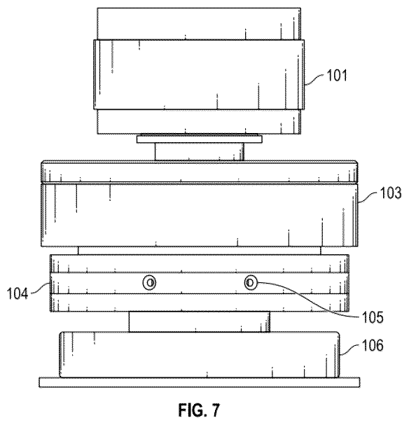

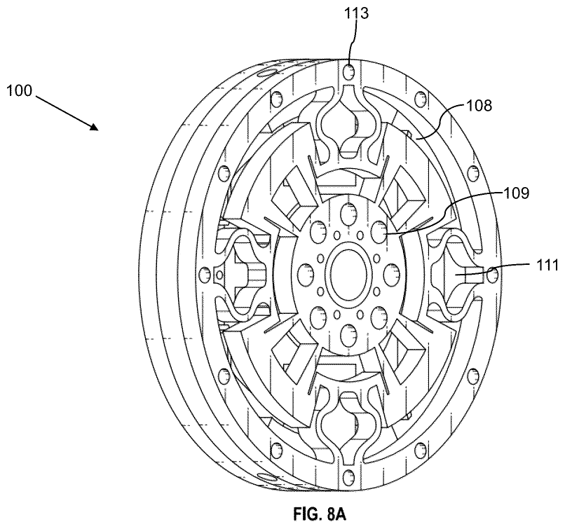

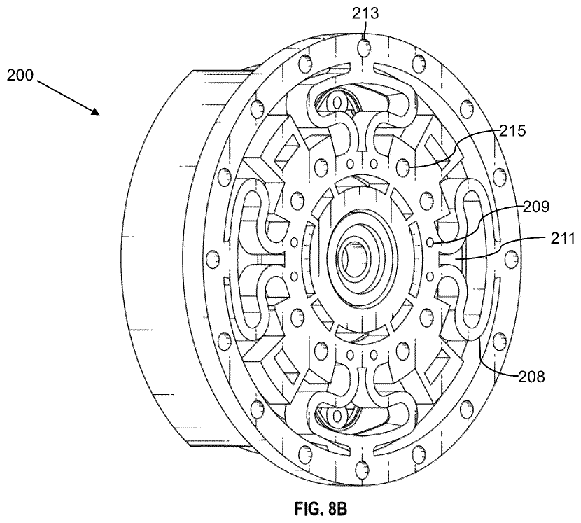

In the depicted FIGS. 2A-2B, the featured compliant actuator adopts a rotary configuration. The key constituents comprising this compliant actuator consist of an electric motor 101, 202, motor encoder 102, 201, gear transmission 103, 203, and an elastic element 104, 204 equipped with a spring sensor 105. The elastic element's output 106, 206 establishes a connection with at least one of a load, a driving linkage, and a driven linkage (described in more detail below).

Further, the motor 102, 201 may include a shaft that establishes a connection with the gear transmission 103, 203, and the output of the gearbox interfaces with the input of the elastic element 104, 204. This system configuration culminates in the mechanical output, which, in most standard applications, corresponds to a robotic joint.

In an embodiment, the electric motor 101, 202 may serve as a primary source of mechanical power for the featured compliant actuator. In some aspects, the electric motor 101, 202 may be a brushless DC motor, stepper motor, or servo motor selected based on torque requirements, speed control precision, and efficiency needs of the application. The electric motor 101, 202 may be coupled to a motor shaft 106, 206 that transmits rotational motion to subsequent components of the actuator assembly. In certain implementations, the electric motor 101, 202 may incorporate built-in gearing or be directly coupled to an external gear transmission 103, 203 to modify the output torque and speed characteristics. The motor 101, 202 may include integrated temperature sensors, encoders, or other feedback mechanisms to enable precise control and monitoring of its operation within the compliant actuator system.

As noted with reference to FIGS. 2A-2B, the output 106, 206 of the elastic element 104, 204 constitutes the principal mechanical interface that couples the motor assembly (motor 101, 202, motor encoder 102, 201, and gear transmission 103, 203) to the remainder of the actuator drivetrain. Depending on the specific embodiment, this output may be: (1) coaxially integrated with the rotor of the motor 101, 202; or (2) functionally linked to the rotor via the intermediary gear transmission 103, 203. During operation, the motor 101, 202 delivers torque that is transmitted through the gear stage (where present) to the elastic element 104, 204. The controlled deflection of the elastic element, which may be monitored in real time by the spring sensor 105, allows its output 106, 206 to relay the conditioned mechanical power onward to the load, a driving linkage, or a driven linkage, thereby completing the power-transmission chain while simultaneously providing intrinsic compliance and measurable torque feedback.

In another embodiment, the shaft 106, 206 may connect directly to the input of the gear transmission 103, 203. Such a connection may be achieved through various means such as splines, keyways, or other mechanical coupling methods that ensure efficient power transfer while preventing slippage. The gear transmission 103, 203 may consist of a series of gears with different ratios, which can modify the speed and torque characteristics of the motor's 101, 202 output.

At the output side of the gear transmission 103, 203, there may be an interface that connects to the input of the elastic element 104, 204. To illustrate, the interface may take various forms depending on the specific design of the elastic element. It could be a shaft, a flange, or a specialized coupling mechanism. The elastic element 104, 204 is designed to deform in a controlled manner when subjected to torque, allowing for compliant behavior in the actuator system.

The arrangement of these components—from the motor shaft 106, 206, through the gear transmission 103, 203, to the elastic element 104, 204—creates a power flow path that transforms the high-speed, low-torque output of the electric motor 101, 202 into a lower-speed, higher-torque input for the elastic element. This configuration allows the system to benefit from both the precise control of the electric motor and the compliant properties of the elastic element, enabling responsive and adaptable actuation in various robotic applications.

While a rotary configuration is described in detail herein, this disclosure should not be limited as such. One skilled in the art would appreciate embodiments utilizing various types of actuators including, but not limited to, gripping/clamping, linear straight motion, lever arms, etc.

Upon the application of an external force onto the actuator located at the mechanical output, the mechanical spring undergoes distortion linearly proportional to said external force, inducing a deflection or displacement. As described herein, reference will be made to a torsion type of deflection, however, other embodiments may include deflections such as elongation, compression, bending, shear deformation, and the like. This displacement manifests in direct proportion to the applied external force, enabling precise force sensing and measurement capabilities within the actuator.

A primary component of the elastic element is a mechanical spring as shown in FIGS. 8A and 8B. The mechanical spring employs the principle of monolithic binary stiffness, demonstrating spring behavior with a peak von Mises stress of 445 MPa at 50 Nm in this configuration. In some implementations, the spring may exhibit a peak stress of 445 MPa when subjected to a torque of 50 Nm, demonstrating its capacity to handle significant loads while maintaining its clastic properties.

The mechanical spring may possess an inherent stiffness of 450 Nm/rad in its default configuration. However, this stiffness characteristic can be adjusted by modifying various design parameters. For instance, altering the spoke radius may affect the spring's overall flexibility and load-bearing capacity. Adjusting the length of the flexible hinges within the spring structure may influence its deflection behavior and force response. Additionally, modifying the ratio between the inner and outer radii of the compliant structure may impact the spring's torsional characteristics and overall stiffness profile.

By manipulating these parameters, the stiffness of the mechanical spring may be tailored to suit specific application requirements. The adjustable stiffness range may extend from approximately 200 Nm/rad to 1000 Nm/rad, providing a wide spectrum of force-deflection responses. This adaptability may allow the actuator to be optimized for various tasks, from those requiring high compliance and sensitivity to applications demanding greater rigidity and force output.

In some cases, the monolithic design of the spring may offer advantages such as reduced part count, elimination of assembly requirements, and potentially improved reliability due to the absence of separate components that could wear or fail. The compliant structure may distribute stress more evenly throughout the material, which may contribute to the spring's ability to handle high loads while maintaining elastic behavior.

The ability to fine-tune the spring's characteristics through geometric adjustments may enable the actuator to be customized for diverse robotic applications without necessitating a complete redesign of the system. This flexibility may be particularly valuable in scenarios where a single actuator design needs to accommodate varying payload capacities or dynamic response requirements across different robotic platforms or end-effectors.

The aforementioned ranges are only meant to be examples to enable one skilled in the art and should not be construed as limiting in any way. In one or more embodiments, the clastic element may have a peak stress above or below 445 MPa at 50 Nm. Further, the adjustable stiffness range may be adjusted to be less than 200 Nm/rad or more than 1000 Nm/rad. In one or more embodiments, the mechanical spring possesses a torque capacity of 50 Nm. A smaller variant has a torque capacity of 30 Nm, while the larger variant has an inherent torque capacity of 200 Nm. Smaller variants may be used in applications where the mechanical spring or elastic element is desired to have less stiffness. Such a desire may arise in the event a higher sensitivity is needed which would require the elastic element to experience less distortion before being sufficiently detected. A smaller variant may also be desired in applications where the actuation mechanism may be moving at high speeds to provide more “cushioning” or forgiveness when interacting with an object. A smaller variant may also be desired in applications where smaller amounts of force are needed when interacting with external objects. A larger variant may be desired when ample distortion amplification may be utilized, and little forgiveness is necessary such as performing actions requiring larger amounts of force.

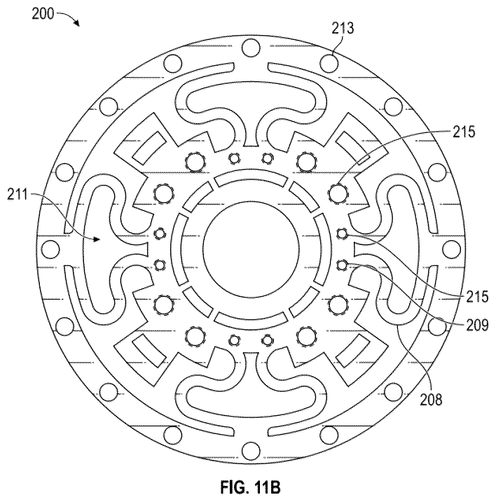

A system and method are developed for scalable adaptation of the mechanical spring design shown in FIGS. 11A and 11B across many variants of torque capacity through the manipulation of parameters in the design. The parameters may encompass material properties and geometric parameters. Material properties may include yield strength, mechanical hysteresis, and safety factor, whereas geometric parameters may consist of the spoke radius, spoke arc length, the distance profiles of the flexible hinges, and the ratio of inner to outer radius. A nonlinear mathematical model has been formulated with parameters and coefficients, streamlining the process of determining new variants with varying torque capacities.

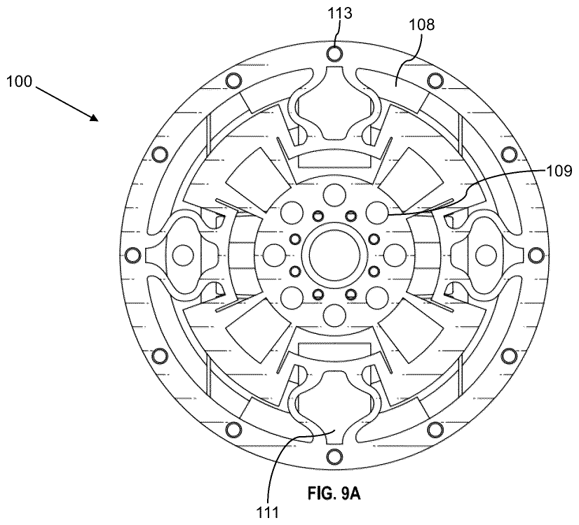

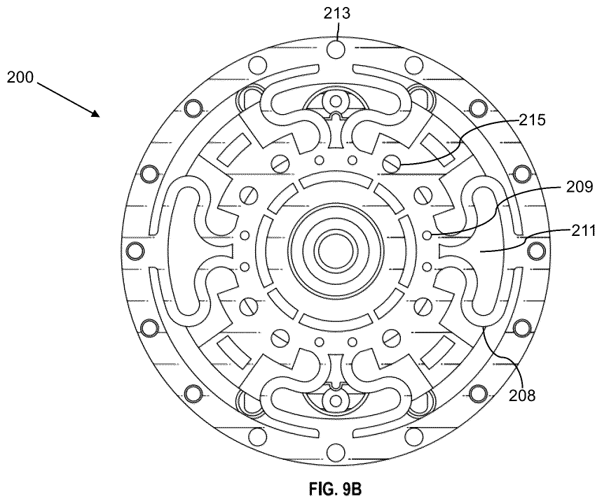

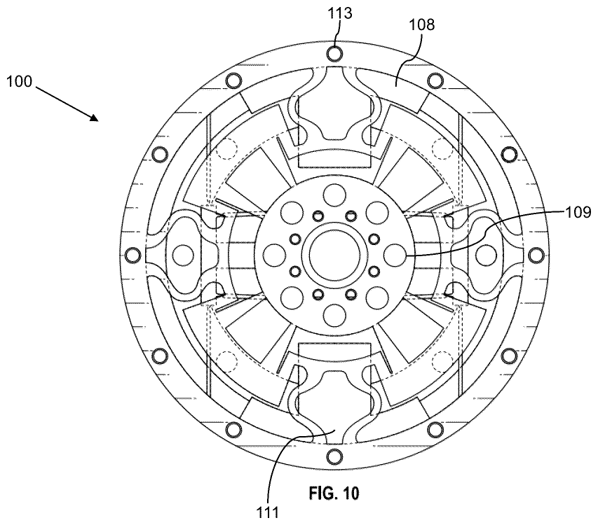

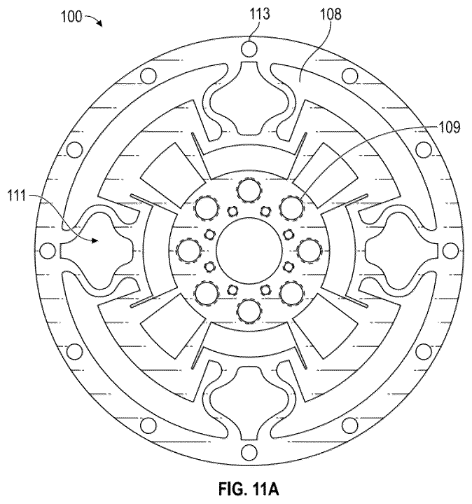

The mechanical spring as shown in assembly FIGS. 9A and 9B are designed for scalability across multiple variations, allowing every variant to be adaptable for diverse applications. Smaller-sized springs with low torque capacity exhibit heightened compliance properties, whereas larger-sized springs with higher torque capacity demonstrate stiff characteristics. Yet in terms of control bandwidth, larger springs surpass that of the smaller ones due to the natural frequency of the material.

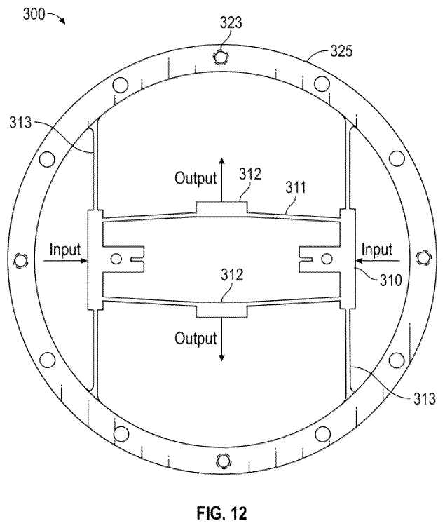

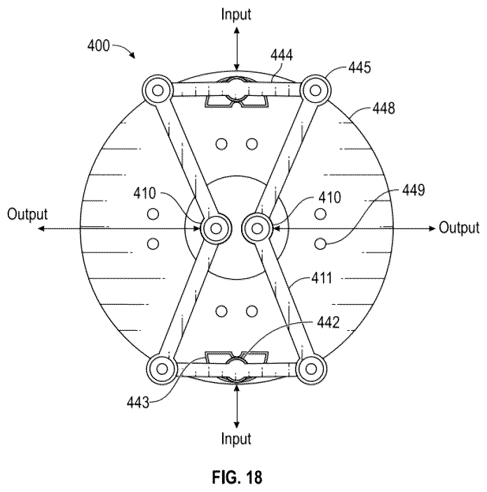

Displacement amplification mechanisms 300, 400 are depicted in the accompanying FIG. 12 and FIG. 18 in accordance with one or more embodiments. These mechanisms are designed to magnify small deflections in the clastic clement, allowing for more precise force sensing and control.

Referring to FIG. 12, the mechanism 300 applies a compliant mechanic's concept referred to as a rhombus bridge. A rhombus bridge in the context of compliant mechanisms is a structural configuration used to enhance the displacement generated by the mechanical spring.

The rhombus bridge mechanism 300 consists of a four-sided geometric figure, held in place with support members 313, with opposite sides of equal length and opposite angles of equal measure and four flexible hinges 311 arranged in the shape of a rhombus that establish connections between the four-sided geometric blocks 310. Said support members 313 may provide structural stability while allowing controlled movement of the mechanism.

As the rotational deflection experienced by the elastic element is transferred to the rhombus-bridge mechanism, a translational force, shown as the input in FIG. 12, is applied to the geometric blocks 310. As the geometric blocks 310 experience this horizontal displacement, the flexible hinges 311 deform elastically. This deformation causes the rhombus shape to distort, resulting in a vertical displacement of the geometric FIGS. 312. The ratio between the input horizontal movement and the output vertical movement determines the amplification factor of the mechanism.

For instance, through the concept of compliant mechanisms, this translational movement of geometric blocks 310 causes the flexible hinges 311 to experience deflection. This deflection causes the geometric FIGS. 312 to experience a change in distance in the output direction.

It should be noted that while a rhombus bridge is described with detail herein, other compliant displacement amplifiers may also be suitable to create a desired amplification factor. Such compliant displacement amplifiers may include, but are not limited to, bridge-type, rhombus type, symmetric five bar structure, lever mechanism, bride-lever-type amplifier, differential amplifier, tensural displacement amplifier, half-scissor amplifier, re-entrant hexagonal honeycomb, 20:1 stroke amplification mechanism, Scott-Russel mechanism, pantograph mechanism, and the like. Each of these alternative mechanisms may offer distinct advantages in terms of amplification ratio, linearity, compactness, or suitability for specific load conditions. The selection of an appropriate amplification mechanism may depend on factors such as the required amplification factor, space constraints, manufacturing considerations, and the specific force-displacement characteristics desired for the actuator system.

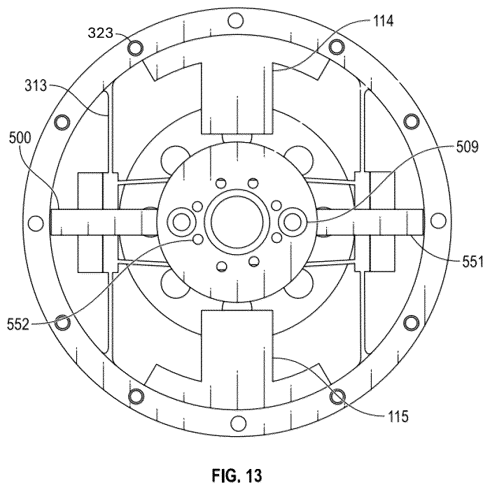

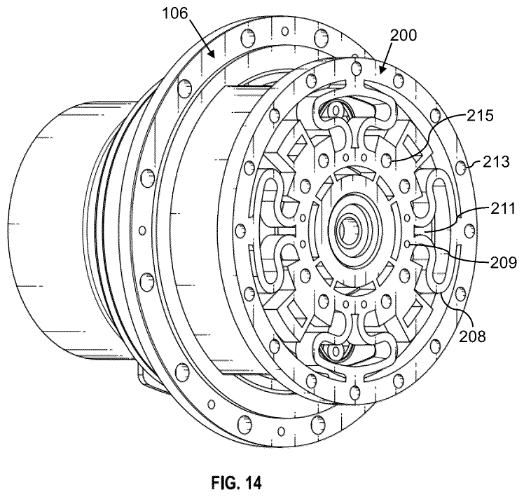

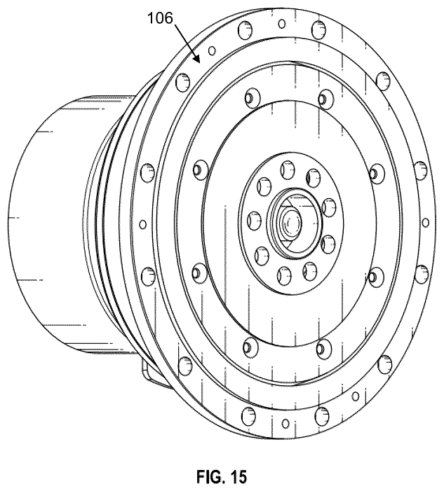

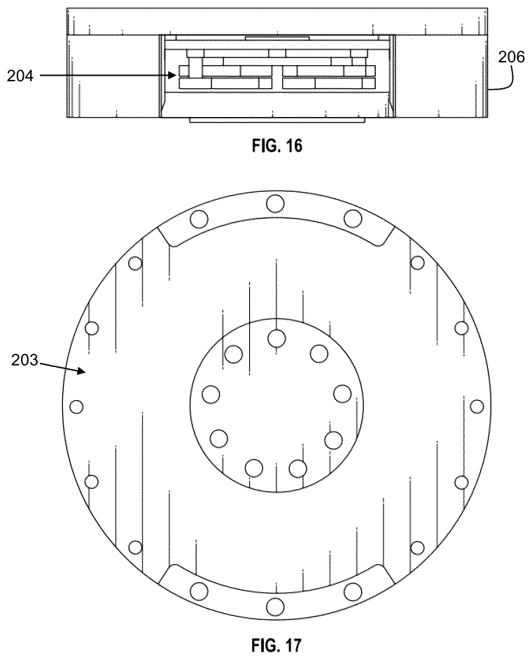

Referring to the embodiments of FIGS. 11A, 11B, and 13, spring inputs 113, 213 are connected to both outer ring holes 323 of the deflection amplifier outer ring 325 and the output of the actuator to prevent movement between the actuator, spring inputs 113, 213, and the deflection amplifier outer ring 325. To illustrate, the spring inputs 113, 213 may be connected to the harmonic gearbox output. Moreover, both outer ring holes 323 are also connected to the gearbox output with 113 and 213, yet 323 are simply used as the function to mount the mechanism and spring input together to gear output. This ensures when the load is transmitted from the joint output, a deflection or relative displacement on the spring can be generated. Or when the motor is transmitting torque through the gearbox, the spring can also be deflected.

When a torsional force is applied to the elastic element 100, 200 via the spring inputs 113, 213, the spokes 111, 211 undergo deflection. As the spokes 111, 211 experience deflection, the spring outputs 109, 209 rotate relative to the spring inputs 113, 213 causing the elastic member 100, 200 to experience rotational distortion. For instance, when torsional force applied on the clastic element 100, it causes a relative displacement between spring outputs 109, 209 and spring inputs 113, 213, such displacement occurs due to the deflection of the spokes 111, 211. This deflection is proportional to the applied force, allowing for precise force measurement. Further, the spokes 111, 211 may contribute to the stiffness and load capacity of a mechanical spring in general. The thickness of the spokes 111, 211, the angular spread of the spokes 111, 211, the radius of the spokes 111, 211 may be the geometric properties that contribute to the spring deflection which results in different spring stiffness and load capacity.

In one embodiment, the spring inputs 113, 213, may be connected to the output of a harmonic gearbox, where spring inputs 113, 213 are connected to the output, which can generally be a robot linkage, an end effector, or the like.

To illustrate, the rotational distortion of the clastic member 100, 200, or mechanical spring as described herein, is then transmitted to the geometric blocks 310 of the rhombus bridge mechanism. These blocks move horizontally in response to the rotational input, initiating the amplification process. The flexible hinges 311 connecting the geometric blocks 310 deform elastically, converting the horizontal motion into vertical displacement of the geometric FIGS. 312 as shown in FIG. 12.

In an embodiment, the elastic member 100, 200, or mechanical spring as described herein, are typically fabricated from materials exhibiting tensile yield strengths in the range of 1200 MPa to 1300 MPa. Finite element analysis reveals that the maximum von Mises stress experienced by each variant under design load conditions remains below 600 MPa. This stress distribution results in a minimum safety factor of 2.0 or greater across all spring variants, ensuring operation well within the elastic regime and providing a substantial margin against plastic deformation or fatigue failure.

The hinges 311 then exhibit flexural behavior, allowing said hinges 311 to bend and deform, translating small horizontal movements into larger vertical displacements. Particularly, the amplification ratio from input to output of this mechanism is set at 1:20. Meaning, that for every unit of displacement at the input, the output experiences 20 units of displacement. This amplification allows for the detection of very small forces or displacements, enhancing the sensitivity of the actuator system. One skilled in the art would appreciate that any number of amplification ratios could be utilized depending on the needs of a particular application. The amplification ratio may be adjusted with the hinge length, the inclination angle of the hinge with respect to the horizontal plane, and the thickness of the mechanism.

In another embodiment, the hinges 311 may be thin structural members that contribute directly to the deflection of a mechanical spring when it experiences load. For example, the thicker the hinges 311, the smaller the amplification ratio may be, which may result in the spring being stiffer as well. The profile of the hinges 311 may also contribute to the elastic element's 100, 200 behavior as well, for example, if the spoke-like shaped hinges have larger diameter, the spring can undergo a larger deflection. In such an example, the elastic element 100, 200 may be softer.

Further, the amplification ratio may be adjusted by modifying several parameters, including, but not limited to, modifying the length of the hinges 311. For example, longer hinges may provide greater flexibility and potentially higher amplification ratios, while shorter hinges may offer more rigidity, precision, and lower amplification ratios.

Moreover, modifying the inclination angle of the hinges 311 with respect to the horizontal plane can alter the amplification characteristics of the system.

Additionally, the thickness of the components, particularly the hinges 311, influences the overall stiffness and responsiveness of the amplification mechanism. Thinner components may allow for greater flexibility and potentially higher amplification, while thicker components may provide more stability and durability.

By fine-tuning the aforementioned parameters, the amplification ratio can be optimized for specific applications. For instance, applications requiring detection of very small forces may benefit from higher amplification ratios, while those dealing with larger forces may require lower ratios to prevent oversaturation of the sensing mechanism. The flexibility in adjusting the amplification ratio allows the actuator system to be adapted for a wide range of applications, from delicate manipulation tasks requiring high sensitivity to more robust applications where larger forces are involved.

The full assembly of the bridge mechanism, as depicted in FIG. 13, illustrates the integration of various components to achieve displacement amplification without the mechanical spring. This assembly demonstrates how rotational motion is converted into amplified translational motion for precise force sensing.

The elastic element's 100, 200 spring outputs 109, 209 are mechanically coupled to the rhombus-bridge driver 500 via through holes 509, 552. This connection ensures that any rotational deflection experienced by the elastic element 100, 200 is directly transferred to the rhombus-bridge driver 500.

As the elastic element 100, 200 undergoes torsional deflection, it induces a corresponding rotation in the rhombus-bridge driver 500. The rhombus-bridge driver 500 serves as a crucial intermediary component, transforming the rotational movement from the driving link 551 into translational movement of the geometric blocks 310. This conversion is key to achieving amplification in the sensing mechanism.

The driving link 551 may be connected to the rhombus-bridge driver 500 in a manner that allows it to transmit rotational motion effectively. As the driving link 551 rotates, it causes the rhombus-bridge driver 500 to rotate as well. The geometry and connection points of the rhombus-bridge driver 500 are designed to convert this rotational input into a translational output that acts on the geometric blocks 310.

In some embodiments, the mechanism may incorporate, or solely comprise, at least one of a gear disc and a cam-lever system for additional amplification. When the mechanical spring deflects, it may cause the gear disc to rotate. This rotation of the gear disc drives the cam-lever mechanism in the opposite direction. The cam-lever mechanism may experience an amplification process due to factors, such as, a change in radius and a change in the center of rotation. For instance, as the cam-lever rotates, the effective radius at which it acts may change, providing a mechanical advantage that amplifies the input motion. Moreover, the cam-lever's center of rotation may shift during operation, which can further contribute to the amplification of motion.

Moreover, the gear disc may bear the slots for the cam-lever as described herein. For example, the diameter of the slots may have direct impact on the ratio of the first stage of amplification. Whereas through holes may be mainly connected to a mechanical spring output.

The rhombus-bridge mechanism 300, the gear disc, and/or the cam-lever mechanism creates a multi-stage amplification system. The initial rotational input from the elastic element 100, 200 is first converted to translational motion by the rhombus-bridge mechanism 300. This motion is then further amplified by mechanism input 310 (also referred to as geometric blocks 310) to output 312 (also referred to as geometric FIGS. 312) through flexible hinges 311, taking the advantages of the rhombus bridge mechanism.

As a nonlimiting example, when a spring undergoes deflection from a load, the disk of mechanism 400 is receiving and rotating radially together with the spring. Then the cam mechanism on the disk pushes the bearing resulting in eccentric displacement, and defining the first stage of amplification.

After the first stage of amplification coming from 442, the displacement continues to move the driving linkage 444 and subsequently the driving linkage 444 triggers the driven linkage 411. Lastly the driven linkage pushes the center rotor that connects to a magnetic or capacitive positional sensor. This process completes the second stage of amplification.

Such a multi-stage approach to amplification may allow for greater overall sensitivity in the sensing mechanism. By leveraging both the geometric properties of the rhombus-bridge configuration and the mechanical advantages provided by the gear system, the assembly can achieve high amplification ratios while maintaining precision and reliability.

The design of each component in this assembly may be optimized to achieve the desired amplification characteristics. Factors such as the geometry of the rhombus-bridge driver 500, the gear ratios in the disc and cam system, and the placement of connection points can all be adjusted to fine-tune the performance of the amplification mechanism for specific application requirements.

In one or more embodiments, two sensing modules 114, 115 are used to sense the distance from the geometric FIGS. 312, thereby enabling precise force detection in the compliant actuator system.

In one configuration, the sensing modules 114, 115 may be positioned to measure the displacement of the geometric FIGS. 312. For example, the sensing modules 114, 115 may be positioned on the rhombus bridge mechanism. These modules may be arranged on opposite sides of the amplification mechanism to provide redundant measurements and enhance accuracy. The dual-sensing module arrangement allows for cross-verification of measurements, potentially improving the overall reliability of the force sensing system.

In an embodiment, the two sensing modules 114, 115 may be in communication. In this way, the measurements collected by each sensing module 114, 115 may be compared to determine whether the amplification mechanism is experiencing uniform distortion. If the measurements from the sensing modules 114, 115 are not uniform, the two measurements may be combined to determine the true distortion of the amplification mechanism. In other embodiments, one, three, or more sensing modules may be utilized.

In one or more embodiments, the sensing modules 114, 115 may be optical sensors configured to measure the change in distances of the geometric blocks. In other embodiments, the sensing modules may be hall effect sensors configured to sense a change in distance of the geometric blocks by sensing a change in magnetic field caused by the change in distance of the magnetic blocks.

Referring to FIG. 18, in one or more embodiments, as elastic element 100, 200 experiences rotational deflection, the gear disc 448, connected to the spring outputs 109, 209 via through-holes 449, rotates with the spring outputs 109, 209. The cam-lever mechanism 442 is rotated in a direction opposite to the rotational deflection of the elastic element 100, 200. As the cam-lever mechanism 442 rotates, the cam-lever mechanism experiences a change in its center of rotation compared to the center of rotation of the elastic element and/or the cam-lever mechanism experiences a change of radius.

This change of center of rotation and/or radius may cause the driving linkage 444 to experience movement in the input direction. This movement of the driving linkage 444 causes the connecting linkage 411 to rotate about a bearing 445. The rotation of the connecting linkage 444 causes the driven linkage 410 to experience movement in the output direction. The gear-cam's change in center of rotation and/or radius allows for a first stage of amplification to the elastic clement's distortion by a factor of m.

The movement of the driven linkage 410 allows for the second stage of amplification. For instance, the second stage of amplification may come from the driving linkage 444 to the connecting linkage 411 through the bearing 445, by the factor of n, this amplification motion is transmitted to the driven linkage 410, completing the second stage amplification. It is the product of m and n that yield the total amplification factor of the elastic element's distortion. A higher amplification factor may allow for more precise measurements of relatively small distortions in the elastic member while smaller amplification factors may be used to measure relatively large distortions in the elastic member.

It should be noted that the terms horizontal and vertical are only to illustrate the perpendicular movement of the geometric figures relative to the geometric blocks, and thus, a person of ordinary skill in the art would appreciate that the geometric blocks and geometric figures may move in any directions, consistent with the effect described above, within three-dimensional space and not just horizontally or vertically. Furthermore, the movement of the geometric figures and the geometric blocks may not be perpendicular but at any angle relative to each other consistent with the effect described above. While first- and second-stage amplifiers are contemplated herein, one skilled in the art would appreciate the possibility of adding any number of stages of amplification to fit the desired need. Using more amplification stages may be desired when the first- and/or second-stage amplifiers cannot create a large enough amplification factor.

There may be observed advantages to using a cam-lever mechanism and 4-bar linkage system over a compliant mechanism to amplify deflection. The cam-lever mechanism and 4-bar linkage system may have less restrictions as to the materials used to create it. Because the cam-lever mechanism and 4-bar linkage system do not experience any flexure under compliant mechanism theory, common materials such as aluminum or stainless steel may be used while mechanisms undergoing mechanical compliance may require composite materials having significantly higher yield strength and durability.

A methodology is developed to scale the displacement amplification mechanism shown in FIG. 12 across multiple variants with varying torque capacities and maximum deflection angles by adjusting design parameters. The parameters include material characteristics like yield strength, mechanical hysteresis, and safety factor, as well as geometric factors such as the length of flexible hinge, the distance profiles of flexible hinges, the dimensions of the driving and driven linkages, overall diameter, initial placement angle of the cam, and the ratio of hinge length and inclination angle of the hinge with respect to the horizontal plane. A mathematical model is established based on the observed linear relationship between these parameters.

In one or more embodiments, the compliant actuator may be implemented in a system utilizing the feedback from the sensing modules to control the force used to control the actuation motion. In such an embodiment, because the distortion of the elastic member is directly proportional to both the movement of the geometric figures and the force of the action mechanism on an external object, the displacement of the geometric figures as measured by the sensing modules may be interpreted to an amount of force exerted by the actuator on an exterior object.

In some applications, it may be necessary to limit the amount of force used on external objects while still performing tasks that require various amounts of force. For example, the actuation mechanism may be handling fragile objects such as glass figurines of various shapes and weights or objects with a low tolerance for damage or destruction such as humans or animals. In such an embodiment, it may be desirable to use the interpreted external force acting on the object in a feedback loop to ensure that too little or too great a force is not used. The feedback from the sensing modules allows the actuator to adjust the force exerted on an external object in real time before having the chance to overexert.

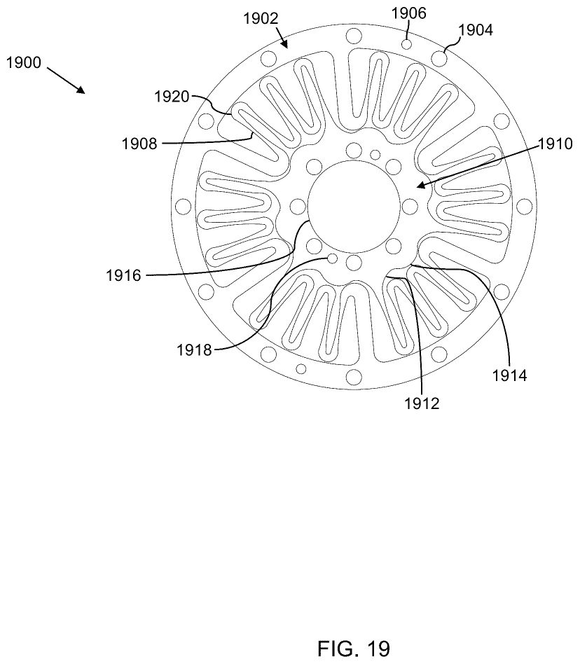

FIG. 19 may illustrate an embodiment of a mechanical spring component incorporating a compliant mechanism design (the “spring”) 1900. The spring 1900 may feature a circular configuration with an outer ring 1902 and an inner ring 1910 connected by flexure spokes 1908 arranged in a radial pattern.

The outer ring 1902 may include mounting holes 1904 and/or dowel pin holes 1906 distributed at regular intervals around a circumference of the outer ring 1902. Said holes 1904/1906 may provide attachment points for integrating the spring 1900 into a larger mechanical assembly.

As a nonlimiting example, the number of mounting holes 1904 may provide a strong connection to either the gearbox or load, such that the torque can be transmitted properly either from the motor 2302 to output, or the load to the gearbox. Fewer mounting holes 1904 may not provide strong mounting to either side, which may cause the spring 1900 to prevent torque from being properly transmitted.

Moreover, the flexure spokes 1908 may extend between the inner ring 1910 and outer ring 1902, forming the primary compliant elements of the mechanism.

Mechanical hardstops 1912 incorporating one or more hardstop walls 1914 may be positioned to limit the radial travel of the flexure spokes 1908. Said hardstops 1912 may prevent excessive deformation of the flexure spokes 1908 under extreme load conditions, protecting the integrity of the spring 1900.

The inner ring 1910 may be further comprised of a central bore 1916 and bolt holes 1918 arranged around said bore's 1916 perimeter. The central bore 1916 may allow for shaft integration or wire routing through the center of the spring 1900. Radial slots 1920 are incorporated between adjacent flexure spokes 1908, which may enhance the compliance characteristics of the mechanism.

The arrangement of the flexure spokes 1908 between the inner ring 1910 and outer ring 1902 may create a compliant mechanism that enables controlled deflection while maintaining consistent mechanical properties. When a force is applied, the flexure spokes 1908 deform elastically, allowing relative motion between the inner 1910 and outer rings 1902. This deformation is designed to be predictable and repeatable, enabling precise force sensing or compliant actuation depending on the specific application.

In one embodiment, the radial space between the inner ring 1910 and the outer ring 1902 may have direct impact to the performance of the spring 1900. A bigger radial space can have more flexure hinges and spokes, which may result in softer and compliant spring, whereas a smaller radial space may cause the spring 1900 to be stiffer and harder.

Furthermore, the spring 1900 may incorporate specific geometric features, such as the curvature of the flexure spokes 1908 or the dimensions of the radial slots 1920, to tune the spring's 1900 stiffness characteristics. The number and arrangement of the flexure spokes 1908 may be optimized to provide uniform compliance in all directions or to create directional stiffness properties as required by the application.

In some implementations, the entire spring 1900 may be manufactured as a single, monolithic piece using materials and processes that ensure high fatigue resistance and consistent mechanical properties. This integrated design may eliminate assembly requirements and reduce potential points of failure, enhancing the overall reliability and performance of the compliant mechanism.

Yet further, the manufacturing tolerances to fabricate the spring 1900 and linkage mechanism may be controlled within 0.01 mm. The mounting holes on the inner 1910 and outer 1902 rings may be controlled within 0.02 mm in mounting diameter. Non-linearity may be introduced if the spring 1900 and mechanism are not fabricated properly.

Additionally, the spring 1900 may be calibrated alongside with the linkage mechanism at its resolution at every step and increment, until the peak torque of the spring 1900 has been reached. A lookup table or function may be established such that at any load condition, including extreme load conditions, and torque estimations are still accurate.

In an embodiment, the spring 1900 may include a set quantity of flexure sections, wherein each flexure section is defined (following FIG. 19 counterclockwise) by a first flexure spoke 1908 bundled portion initially protruding from the inner ring 1910 towards the outer ring 1902, a second flexure spoke 1908 bundled portion, a third flexure spoke 1908 bundled portion, and a thick flexure spoke 1908 portion connecting the third flexure spoke 1908 bundled portion to the outer ring 1902. A flexure spoke 1908 bundled portion may be defined as two thin, generally parallel flexure spoke 1908 segments joined by a curved apex portion positioned closer to the outer ring 1902. As a nonlimiting example, FIG. 19 depicts six flexure sections radially disposed within the spring 1900. In various embodiments, the spring 1900 may include two, three, four, five, six, seven, eight, nine, ten, or more flexure sections. The spring 1900 may include six flexure sections, each section comprising three flexure spoke bundled portions, at least one flexure section connected to the inner ring 1910, and at least one flexure section connected to a thick flexure section portion, wherein the thick flexure portion is further connected to the outer ring 1902. In an embodiment, a flexure section may include one, two, three, four, five, six, seven, eight, nine, ten, or more flexure spoke 1908 bundled portions and one or more thick flexure portions. In various embodiments, the flexure spoke 1908 bundled portions may be of any width, wherein said width is less than the width of the thick flexure portion.

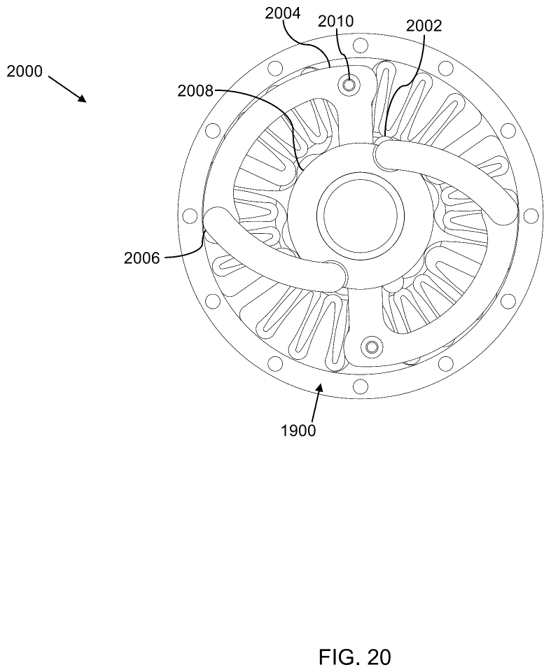

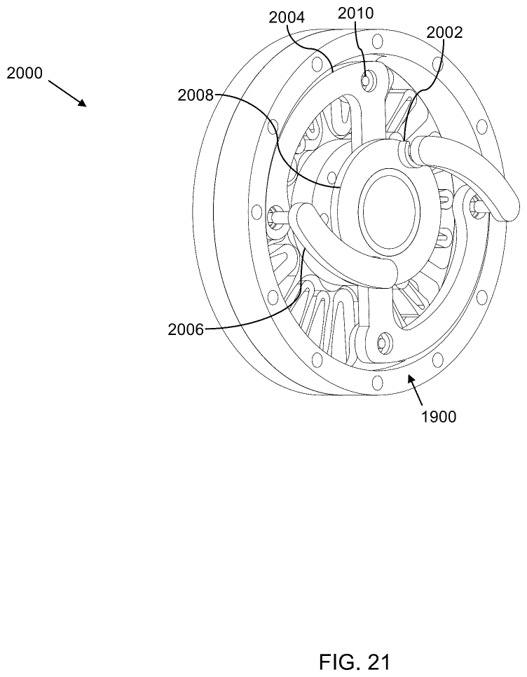

Moving to FIGS. 20 and 21, an orthogonal front view of cam-lever mechanism 2000 may be illustrated. The mechanism 2000 features a circular configuration with multiple components arranged in a concentric pattern, designed to amplify small angular deflections of a mechanical spring. As a nonlimiting example, the cam-lever mechanism 2000 may be the same as the displacement amplification mechanism 400.

The cam-lever mechanism 2000 includes a cam 2002 comprising two cylindrical cams mounted on a small plate, rigidly fixed to the inner ring 1910 of the spring 1900. The cam's 2002 placement and working face are precisely profiled to convert a given angular input into an increasing amount of linear and radial travel at the follower interface.

A driving linkage 2004, also referred to as the first lever, is a slender, pivoted arm that rides on a face of the cam 2002. The distal end of the driving linkage 2004 converts the cam's 2002 radial motion into tangential rotation about its own pivot, providing the first stage of amplification.

A driven linkage 2006, or second lever, is hinged to the frame at a separate pivot point and is actuated by the tip of the driving linkage 2004. The geometry of the driven linkage 2006 is proportioned such that a unit input rotation from the driving linkage 2004 produces a further ratio of z in rotation at its output. As a nonlimiting example, the amplification ratio during the first stage of amplification may be x, and the amplification ratio during the second stage of amplification may be y. Thus, the total amplification ratio may be z.

Furthermore, upon the first stage of amplification coming from cam 2002 (described in more detail below), the displacement continues to move the driving linkage 2004 and subsequently the driving linkage 2004 triggers the driven linkage 2006. The driven linkage 2006 may push the center rotor that connects to a magnetic or capacitive positional sensor. Such a process completes the second stage of amplification.

A sensing rotor 2008, a light and stiff disc, is coupled to the output of the driven linkage 2006. This rotor 2008 interfaces with optical, magnetic, or capacitive position sensors and experiences z times the angular excursion of the original spring deflection.

When an external torque twists the spring 1900, the inner ring 1910 rotates by a small angle θ. The rigidly mounted cam 2002 translates this rotation into a radial displacement δ, delivering the first stage of amplification. This displacement forces the driving linkage 2004 to rock about its pivot, transmitting the amplified motion at its tip to the driven linkage 2006. The driven linkage 2066 subsequently multiples the rotation again, completing the second stage of amplification at the sensing rotor 2008.

The mechanism 2000 is designed to be purely mechanical, with all joints implemented as plain pivots or flexure pins within the same thin axial plane. This design choice ensures negligible backlash and maintains stiff dynamic coupling up to the sensor bandwidth.

The configuration efficiently packs a coaxial, backlash-free two-stage cam-lever train into the same planar envelope as the SEA's compliant disc. This arrangement significantly multiplies the spring's 1900 minute torsional deflection without adding more axial height to the assembly. The eccentrically profiled cam 2002, rigidly bonded to the load-side ring, first multiplies the motion at the follower arm (driving linkage 2004). The driving linkage 2004, cut as a monolithic lever with precisely set pivot spacing, imparts its travel to the driven linkage 2006. The geometry of the driven linkage 2006 further amplifies the rotation, resulting in the final sensing rotor 2008 swinging through an angle much larger than the original spring twist.

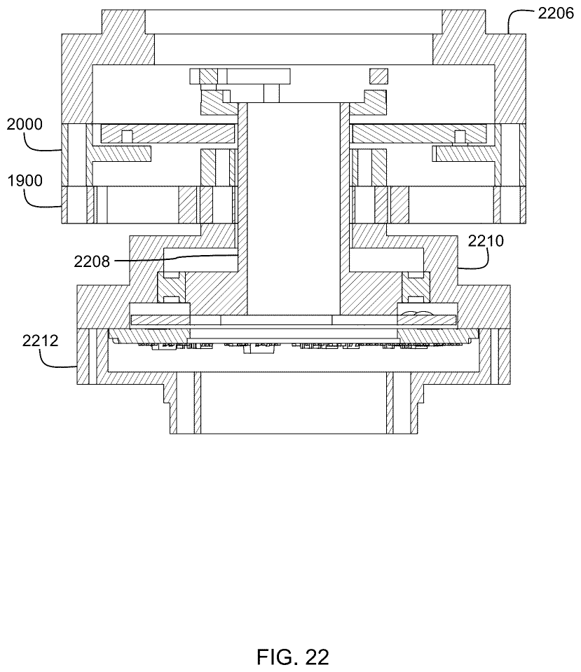

Turning to FIG. 22, a section view of a compliant elastic assembly showing the internal arrangement of components may be illustrated. The assembly is designed as a thin, cylindrical cartridge with an outer diameter matching the motor frame, allowing for drop-in installation between a gearbox and load.

A connector flange 2206 serves as an annular adaptor keyed or bolted to the gearbox output hub. Such a flange 2206 may transfer motor torque into the torque sensor cartridge while providing axial and radial location for the assembly.

The spring 1900 consists of monolithic S-shaped beams as described in FIG. 19. It is fastened at the spring's 1900 inner ring 1910 to connector 2210 and at its inner hub to connector 2210. This spring 1900 provides sensitive torque sensing with calibrated torsional compliance and overload protection.

The cam-lever mechanism 2000 is mounted concentrically on the spring 1900. This stacked cam-and-double-lever train includes a rigid cam 2002 bonded to the spring's 1900 inner hub that drives the driving linkage 2004, which in turn actuates the driven linkage 2006. This mechanism provides a significant amplification ratio of 4 to 10 times.

A sensing-rotor shaft 2208 is a light, stiff shaft carried on miniature bearings. It is rigidly attached to the output of the driven linkage 2006 and presents a slotted or patterned rotor to an external optical, magnetic, or capacitive encoder 2010.

The connector flange 2210 couples the spring's 1900 inner ring 1910, and therefore the entire output of the compliant element, to the downstream joint link or tooling plate.

An output shaft 2212 serves as the final load-side shaft or stub that interfaces with the robot joint, end-effector, or any fixture. It is rotatably locked to connector 2210.

In operation, drive torque from the gearbox passes through the connector flange 2206 into the outer ring 1902 of spring 1900. Under load, the output shaft 2212 transmits torque through the connector 2210, and then subsequently to the spring's 1900 inner hub, causing the spring 1900 to twist by a small angle. The differential motion between the spring's 1900 outer and inner flanges is captured by the cam 2002 inside the cam-lever mechanism 2000, which rocks the driving linkage 2004. The driving linkage 2004 then drives the driven linkage 2006, causing the sensing-rotor shaft 2208 to rotate by a specific ratio.

An external encoder measures this amplified rotation, yielding a high-resolution, low-noise estimate of delivered torque (T=k θ) without exposing the sensor to full load.

This torque-sensor module uniquely combines a fatigue-optimized planar torsion spring and a backlash-free two-stage cam-lever amplifier into a single coaxial module. It is designed to fit directly between a gearbox and its load, with adaptor 2206 delivering motor torque into the spring's 1900 outer flange and adaptor 2210 feeding the calibrated, compliance-filtered torque to the output shaft 2212. The minute relative twist of the spring 1900 is amplified by the cam 2002 and dual-lever train 2004/2006, allowing the sensing rotor shaft 2208 to swing through a large, encoder-friendly angle without the need for gears, magnets, or strain gauges in the load path.

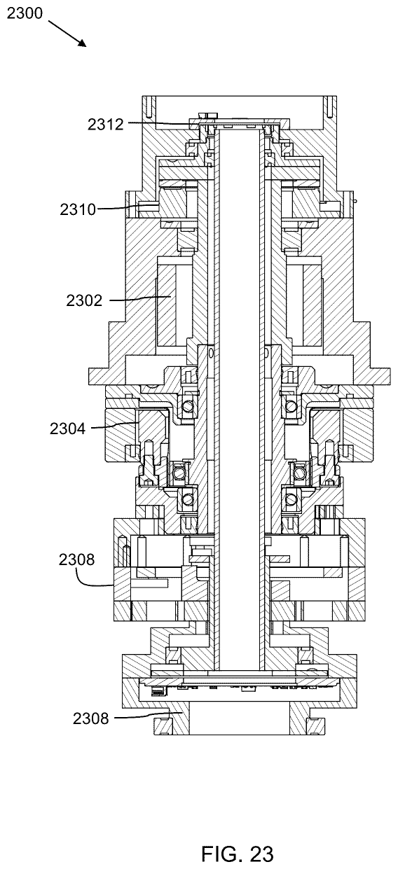

Referring to FIG. 23, a section view of a rotary compliant actuator 2300 showing the internal arrangement of components may be illustrated. The section view reveals a stacked configuration of mechanical elements arranged along a central axis.

Such a rotary compliant actuator 2300 may include a motor 2302, said motor 2302 is a frameless, high-torque brushless DC motor packaged in a thin pancake form. Its stator is secured to the actuator housing while the rotor is fixed to the gearbox input shaft.

At the top of the assembly is the motor 2302 and output encoder stack 2312. This dual-track absolute encoder 2312 is mounted on the back iron of the motor 2302, reading both the rotor position for current motor 2302 commutation and post-gear output angle through a hollow shaft. This configuration enables single-device measurement of both positions without extra axial length.

A fail-safe brake 2310 is positioned below the encoder 2312 stack. This normally-closed, permanent-magnet disc brake 2310 is integrated into the motor 2302. It locks the drivetrain when power is removed, guaranteeing safe holding even if the spring element is fully deflected.

The rotary compliant actuator 2300 may include a harmonic drive gearbox 2304 situated below the brake 2310. This zero-backlash, high-ratio strain-wave reducer has its cup driven directly by the motor's 2302 rotor, and its rigid output flange delivers amplified torque into the torque sensor module.

An elastic torque sensor module 2306 is positioned below the gearbox. This module 2306 consists of a planar torsion spring with a cam-lever amplifier. Its outer flange is bolted to the gearbox output while its inner flange drives the output shaft, providing calibrated compliance, overload protection, and high-resolution torque read-out.

At the bottom of the assembly is an output shaft 2308. This hollow, through-bored shaft 2308 transmits torque to the robot joint. Its bore allows signal lines or wires to pass straight through the joint axis.

In operation, torque from the motor 2302 passes through the brake 2310 into the harmonic gearbox 2304, emerging at high torque/low speed at the reducer's rigid flange. The flange may drive the outer ring of the elastic torque sensor 2306. The calibrated planar spring twists by a small angle θ under load while its inner hub (via the cam-lever amplifier) rotates the output shaft 2308 by the same θ. The built-in amplifier multiplies the deflection θ, swinging the sensing rotor inside the torque sensor module 2306 so the encoder 2312 can resolve torque down to specific resolution after calibration.

This actuator 2300 uniquely unifies a frameless BLDC motor, fail-safe brake, zero-backlash harmonic reducer, and a fully self-contained, series-elastic torque-sensor cartridge in a single stack. The motor's 2302 dual-track encoder 2312 simultaneously commutates the rotor and reads post-gear output position through a hollow shaft 2308, eliminating a separate output encoder. The spring-based torque sensor 2306 sits directly on the reducer flange with calibrated compliance, intrinsic overload protection, and a mechanically amplified torque signal immune to electromagnetic drift. The normally-closed brake 2310 is sandwiched between motor 2302 and encoder 2312 so it locks the drivetrain even if the elastic element is at full deflection, guaranteeing safe holds in power loss conditions.

All sub-assemblies share common dowelled datum faces, so axial and radial alignment are preserved during field swapping of the torque cartridge or brake without laser realignment. The hollow output shaft 2308 preserves a continuous bore for wiring, altogether delivering a compact, serviceable, high-fidelity force-controllable actuator unmatched by prior art that relies on bulky strain-gauge shafts or external torque cells.

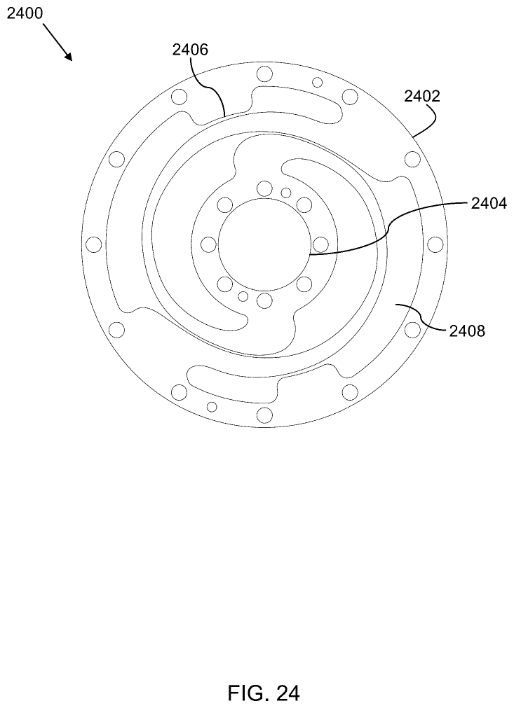

Moving to FIG. 24, an orthogonal front view of a mechanical spring component incorporating a compliant mechanism design (the “spring”) 2400 may be illustrated. The spring 2400 features a circular configuration with an outer attachment ring 2402 and an inner hub 2404 connected by flexure spokes 2142 arranged in a radial pattern.

The outer attachment ring 2402 is a wide annular flange with a concentric bolt-circle pattern. This ring is designed to mate with the motor 2302 or gearbox-side output shaft, providing a secure connection to the drive side of the actuator system.

The inner hub 2404, also referred to as the inner ring, is a rigid central boss that is drilled with a bolt-circle pattern. This hub 2404 is intended to couple with the load-side member, which may be a link, joint housing, or end-effector. A through-bore at the center of the inner hub 2404 preserves a path for encoder shaft 2312 and wire routing, allowing for efficient integration of sensing and control components.

Two spiral flexure spokes 2408 connect the inner hub 2404 to the outer attachment ring 2402. These spokes 2408 are designed to bend in-plane and twist about their own axes when subjected to differential torque. This design delivers a highly linear torsional compliance while rejecting radial and axial motion, ensuring that the joint axis remains coaxial and axial positional accuracy is maintained.

Integrated hard-stops 2406 are positioned to limit the radial travel of the flexure spokes 2408. When the design torque is exceeded, these mechanical hard-stops 2406 prevent further strain in the flexures, protecting the spring from plastic deformation. This feature acts as a built-in mechanical fuse without requiring additional parts.

When torque T is applied between the outer attachment ring 2402 (drive side) and inner hub 2404 (load side), it is shared equally by the flexure spokes 2408. The aggregate torsional spring constant k results in an angular deflection θ=T/k. The compliant deformation is confined to in-plane flexure, maintaining the coaxiality of the joint axis and preserving axial positional accuracy.

This planar torsion spring 2400 uniquely integrates a high-compliance elastic element with overload-protection hard-stops. The constellation of symmetric S-shaped spokes carved through the sheet yields a strictly torsional, highly linear compliance while inherently cancelling parasitic radial stretch and tilt. The smoothly filleted slot paths and vent-style relief openings in the flexure spokes help to distribute strain uniformly across the structure.

The design of this spring component 2400 allows for precise force sensing and controlled compliance in various applications such as robotic joints, haptic devices, or precision measurement instruments. The integration of compliance and overload protection in a single, monolithic structure may enhance reliability and simplify assembly in actuator systems.

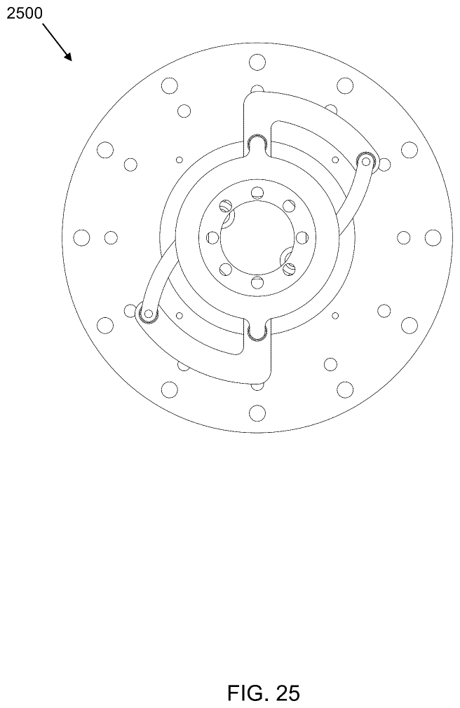

Turning to FIG. 25, an embodiment of a cam-lever mechanism 2500 may be illustrated. Such an amplification mechanism 2500 may amplify a deflection angle in 1:10 ratio.

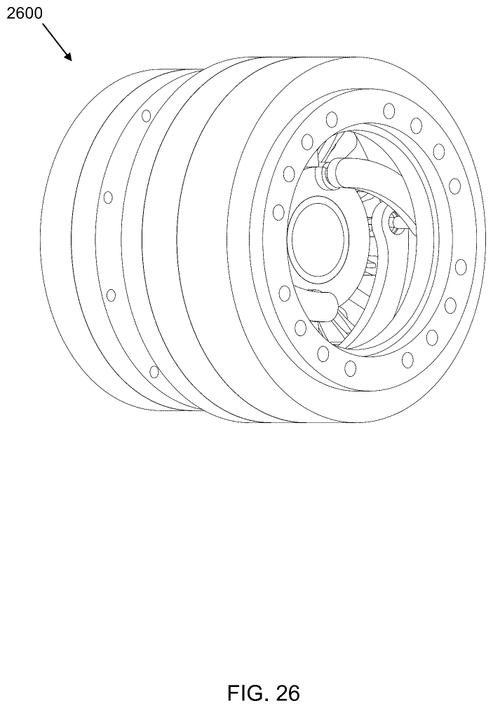

Referring to FIG. 26, an embodiment of a complete elastic element 2600 in panel view may be illustrated.

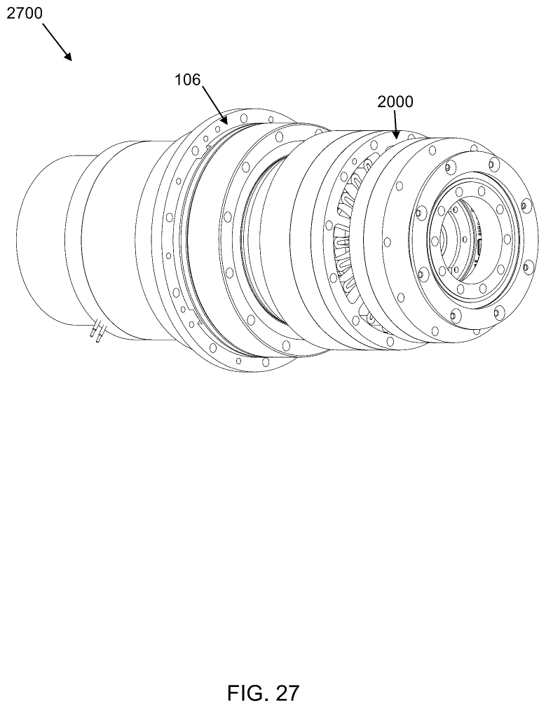

Lastly, FIG. 27 may illustrate an embodiment of a complete robotic compliant actuator 2700 in panel view.

The present disclosure may relate to a compliant actuation system. In an embodiment, the system may comprise an elastic element and a deflection sensing mechanism. The elastic element may be designed to undergo controlled deflection in response to external forces, while the deflection sensing mechanism amplifies and measures this deflection.

Further, the elastic element may include an outer ring with multiple mounting holes distributed around its circumference. Said mounting holes may be used to secure the elastic element within a larger mechanical assembly or to interface with other components of the actuation system. The outer ring may be connected to an inner hub via a plurality of flexure spokes that extend radially between them.

The flexure spokes may be designed to allow controlled deformation under load. Each spoke may incorporate one or more flexible hinges along its length. These hinges are regions of reduced cross-section or specially shaped sections that facilitate bending and twisting of the spokes. The flexible hinges may allow the spokes to deform elastically when subjected to forces, providing the compliant behavior of the element.

To prevent excessive deformation that could lead to permanent damage, mechanical hardstops are positioned to limit the radial travel of the flexure spokes. These hardstops may be integrated into the design of the elastic element or could be separate components. When the deflection reaches a predetermined limit, the spokes contact these hardstops, preventing further deformation.

The deflection sensing mechanism is coupled to the elastic element to amplify and measure its deflection. This mechanism includes several components working in concert:

A cam may be rigidly affixed to the inner hub of the elastic element. As the elastic element undergoes rotational deflection, the cam rotates with it. The cam's profile is designed to translate this rotational movement into radial displacement. The specific shape of the cam determines the relationship between angular deflection and radial movement.

Engaging with the cam is a driving linkage, which is pivotally mounted. As the cam rotates and produces radial displacement, it causes the driving linkage to pivot. This pivoting motion effectively converts the radial displacement back into rotational motion, but with amplification due to the geometry of the linkage.

The driving linkage interacts with a driven linkage, which is also pivotally mounted. The motion of the driving linkage is transmitted to the driven linkage, causing it to rotate. The geometry and pivot points of these linkages are designed to further amplify the motion.

Finally, a sensing rotor is coupled to the output of the driven linkage. This rotor undergoes angular excursion proportional to the original deflection of the elastic element, but significantly amplified through the cam and linkage mechanism. The sensing rotor may interface with various types of sensors (e.g., optical, magnetic, or capacitive) to precisely measure its rotation, thereby providing a high-resolution measurement of the elastic element's deflection.

This arrangement allows the system to measure very small deflections of the elastic element with high precision. The amplification provided by the cam and linkage system enables the use of conventional sensors to measure what would otherwise be imperceptibly small movements. This high-resolution force sensing capability is crucial for applications requiring precise force control or feedback.

As this invention is susceptible to embodiments of many different forms, it is intended that the present disclosure be considered as an example of the principles of the invention and not intended to limit the invention to the specific embodiments shown and described.

While this invention has been described with respect to at least one embodiment, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed:

1. A compliant actuation system comprising a compliant actuator, the compliant actuator comprising:
an actuator coupled to an elastic element,
wherein the elastic element is configured to undergo an amount of deflection in a first direction, and wherein the amount of deflection is proportional to an external force exerted by the actuator; and
a deflection sensing mechanism configured to measure a deflection of the elastic element.

2. The compliant actuator of claim 1, wherein the deflection sensing mechanism comprises an amplification mechanism, the amplification mechanism comprising:
a gear-cam coupled to the elastic element, wherein the gear-cam is configured to rotate in an opposite direction to the first direction; and
a linkage system coupled to the gear-cam, wherein the linkage system is configured to distort in proportion to the rotation of the gear-cam.

3. The compliant actuator of claim 2, wherein the linkage system comprises a four-bar linkage mechanism.

4. The compliant actuator of claim 2, wherein the gear-cam magnifies the deflection by a first amplification factor of m, and wherein the linkage system magnifies the deflection by a second amplification factor of n.

5. The compliant actuator of claim 4, wherein a total amplification factor is the product of the first amplification factor of m and the second amplification factor of n.

6. The compliant actuator of claim 1, wherein the elastic element further comprises one or more spokes, wherein the one or more spokes are configured to experience deflection proportional to the external force exerted by the actuator.

7. The compliant actuator of claim 1, wherein the measured deflection of the elastic element corresponds to the external force exerted by the actuator.

8. The compliant actuator of claim 7, wherein the actuator is configured to adjust the external force exerted by the actuator based on the measured deflection of the elastic element.

9. The compliant actuator of claim 1, wherein the amount of deflection is linearly proportional to the external force exerted by the actuator.

10. A system, comprising:
an elastic element configured to undergo deflection in response to an external force;
a deflection sensing mechanism coupled to the elastic element, the deflection sensing mechanism including a gear-cam and a linkage system;
the gear-cam configured to rotate in a direction opposite to the deflection of the elastic element and magnify the deflection by a first amplification factor;
the linkage system configured to distort in proportion to the rotation of the gear-cam and magnify the deflection by a second amplification factor.

11. The system of claim 10, wherein the elastic element includes one or more spokes configured to experience deflection proportional to the external force.

12. The system of claim 10, wherein the gear-cam is configured to magnify the deflection by a first amplification factor greater than one.

13. The system of claim 10, wherein the measured deflection of the elastic element corresponds to the external force exerted by the actuator.

14. The system of claim 10, wherein the linkage system includes a four-bar linkage mechanism.

15. The system of claim 10, wherein the gear-cam is configured to rotate in a direction opposite to the deflection of the elastic element and magnify the deflection by the first amplification factor.

16. The system of claim 15, wherein the linkage system is configured to distort in proportion to the rotation of the gear-cam and magnify the deflection by the second amplification factor.

17. A compliant actuation system comprising:
an elastic element configured to undergo deflection in response to an external force, the elastic element comprising:
an outer ring having a plurality of mounting holes distributed around its circumference,
an inner hub,
a plurality of flexure spokes extending radially between the outer ring and the inner hub,
mechanical hardstops positioned to limit radial travel of the flexure spokes; and
a deflection sensing mechanism coupled to the elastic element, the deflection sensing mechanism including:
a cam affixed to the inner hub of the elastic element,
a driving linkage pivotally mounted and configured to engage with the cam,
a driven linkage pivotally mounted and configured to be actuated by the driving linkage, and
a sensing rotor coupled to an output of the driven linkage.

18. The compliant actuation system of claim 17, wherein each of the plurality of flexure spokes incorporate one or more flexible hinges allowing controlled deformation.

19. The compliant actuation system of claim 17, wherein the cam is configured to translate rotational deflection of the elastic element into radial displacement.

20. The compliant actuation system of claim 17, wherein the driving linkage is configured to convert the radial displacement into rotational motion.
